(19) United States
(12) Patent Application Publication
(10) Pub. No.: US 2008/0313018 A1
(43) Pub. Date: Dec. 18, 2008

(54) System and Method for Prime Lead Data Commercialization

(76) Inventors: John W. Kamm, IV, Austin, TX (US); Andrew S. Price, Austin, TX (US); Joseph A. Liemandt, Austin, TX (US); Vishnu G. Sunderam, Bangalore (IN)

Correspondence Address: HAMILTON & TERRILE, LLP, P.O. BOX 203518, AUSTIN, TX, 78720, US

(21) Appl. No.: 12/138,631

(22) Filed: Jun. 13, 2008

Related U.S. Application Data
(60) Provisional application No. 60/943,989, filed on Jun. 14, 2007.

(51) Int. Cl. G06Q 10/00; G06Q 50/00; G06Q 30/00

(52) U.S. Cl. 705/10; 705/400

(57) ABSTRACT

A prime lead data commercialization system and method, in at least one embodiment, filters lead data to identify prime leads, provides the prime leads to a recipient, and determines compensation to the lead source based upon conversion rates. By shifting compensation risk to the lead source, the prime lead data source is able to obtain leads from any lead source without introducing arbitrary lead filtering criteria, such as filtering based on historically unacceptable conversion rates that would have otherwise omitted quality leads. The prime lead data source can establish filter criteria that restricts the lead data that the prime lead data source purchases. The prime lead data commercialization system can determine compensation based upon a premium pricing model. Accordingly, the risks of compensation based on conversion rates can be offset by justified premium pricing models for prime leads.

### CROSS-REFERENCE TO RELATED APPLICATION

(1) This application claims the benefit under 35 U.S.C. § 119(e) and 37 C.F.R. § 1.78 of U.S. Provisional Application No. 60/943,989, filed Jun. 14, 2007 and entitled “System and Method For Prime Lead Data Commercialization.” U.S. Provisional Application No. 60/943,989 includes example systems and methods and is incorporated by reference in its entirety.

### BACKGROUND OF THE INVENTION

1. Field of the Invention

(2) The present invention relates in general to the field of information processing, and more specifically to a system and method for commercializing prime lead data.

2. Description of the Related Art

(3) Many product dealers generate sales by following-up with leads. Leads represent potential customers. Product dealers obtain lead data from any of a variety of sources. Lead data includes information about a lead, such as contact information, a lead generation date, and product interest. The Internet has proliferated the volume of generated lead data. The conversion rate of a set of purchased leads is, in at least one embodiment, the percentage of leads that purchase a product after a dealer representative contacts the lead out of the total number of leads purchased by the product dealer. Product dealers take a chance that the conversion rate of the lead data will be sufficiently high to justify the cost of purchasing the lead data. The term “products” as used herein refers to tangible products and intangible products, such as services or organizational support for, for example, charitable and political organizations.

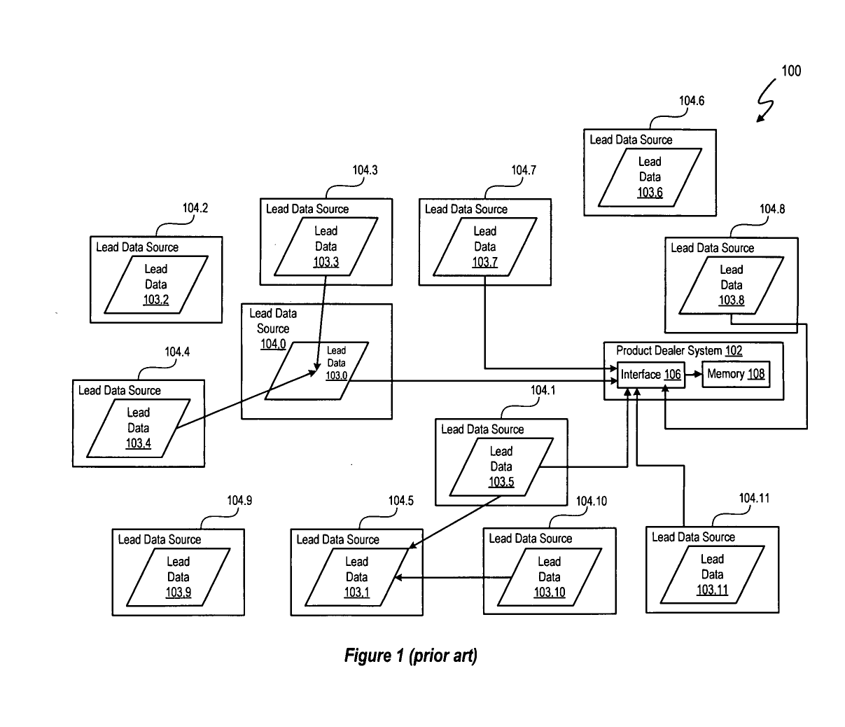

(4) FIG. 1 depicts a lead data purchase system 100 that allows product dealers to receive lead data from a variety of lead data sources. The lead data purchase system 100 includes a dealer system 102 that receives lead data from lead data sources selected from the set of lead data sources 104.0, 104.1, . . . , 104.N, where N is an integer greater than or equal to zero. In at least one embodiment, the dealer system 102 includes an interface 106 to receive lead data in electronic form and a memory 108 to store the lead data. In at least one embodiment, the lead data is stored in a database or in a structured file, such as an extensible markup language (XML) file.

(5) Lead data can be generated using any of a variety of methods. For example, lead data can be generated by users of a web site completing and submitting an electronic ‘lead data’ form. Lead data can also be generated by other means, such as through paper mail solicitations and telephone interviews. The lead data, in any form, is collected by one or more of the lead data sources 104.0, 104.1, . . . , 104.N. A lead data source, such as lead data sources 104.2, 104.3, . . . , 104.10, may be a web site owned by an entity that, for example, sells related products and/or provides information related to the products from which lead data is collected. In another embodiment, a lead data source may be a lead data broker, such as lead data brokers 104.0 and 104.1, that respectively collect and aggregate lead data from other lead data sources. The lead data source may take any other form, such as a telemarketing lead data source 104.11.

(6) The product dealer pays for each lead received from a lead source. Product dealers often have access to a very large number of leads from a variety of lead sources. The product dealers may introduce some initial lead-specific and arbitrary filtering criteria that establish eligibility requirements for lead data purchases. Accordingly, the product dealer generally purchases lead data from only a proper subset of the available lead data sources 104.0, 104.1, . . . , 104.N that meet predefined criteria of the product dealer. For example, the product dealer may purchase lead data if the leads in the lead data have at least a certain minimum credit score, have a valid telephone number, and were submitted within a certain time frame represent lead-specific criteria. Other filtering criteria arbitrarily filter out leads. For example, arbitrary criteria include, for example, the price of each lead and the historical conversion rate of leads from a lead data source. Additionally, the volume of available lead data often surpasses the ability of the dealer to follow-up with a lead on a timely basis. Thus, the dealer may limit the volume of purchased leads, which has the effect of arbitrarily filtering leads. Also, the filtering criteria can filter out leads that would have resulted in a conversion, i.e. a sale. For example, if a lead source is excluded for historically unacceptable conversion rate performance, any leads present in the lead data from the excluded lead source that would have converted will not be available to the product dealer. Also, the filter criteria can have flaws that filter out quality leads or accept low quality leads.

(7) In any event, once a product dealer elects to purchase lead data, regardless of any pre-filtering of the lead data, the product dealer pays the lead source a predetermined amount for the lead data. Thus, the product dealer takes the risk that the conversion rate of the lead data will justify the cost of the lead data while potentially excluding quality leads.

### SUMMARY OF THE INVENTION

(8) In one embodiment of the present invention, a method for commercializing prime lead data using a computer system includes receiving lead data, wherein the lead data includes multiple leads and each lead includes information identifying a potential sales prospect. The method further includes determining a measure of quality of each lead and generating a set of prime lead data from the leads that are evaluated as valid and have a predetermined measure of quality. The method also includes providing the prime lead data to a recipient and determining compensation for the prime lead data based on a predetermined threshold conversion rate of leads included in the prime lead data into sales of a product.

(9) In another embodiment of the present invention, a computer system includes one or more processors. The computer system also includes a memory, coupled to the processor, having code stored therein and executable by the one or more processors for:
receiving lead data, wherein the lead data includes multiple leads and each lead includes information identifying a potential sales prospect;
determining a measure of quality of each lead;
generating a set of prime lead data from the leads that are evaluated as valid and have a predetermined measure of quality;
providing the prime lead data to a recipient; and
determining compensation for the prime lead data based on a predetermined threshold conversion rate of leads included in the prime lead data into sales of a product.

(10) In another embodiment of the present invention, a computer readable medium includes code stored therein and executable by a processor for:
receiving lead data, wherein the lead data includes multiple leads and each lead includes information identifying a potential sales prospect;
evaluating validity of the leads;
determining a measure of quality of each lead;
generating a set of prime lead data from the leads that are evaluated as valid and have a predetermined measure of quality;
providing the prime lead data to a recipient; and
determining compensation for the prime lead data based on a predetermined threshold conversion rate of leads included in the prime lead data into sales of a product.

(11) In a further embodiment of the present invention, an apparatus for commercializing prime lead data using a computer system includes means for receiving lead data, wherein the lead data includes multiple leads and each lead includes information identifying a potential sales prospect. The apparatus also includes means for determining a measure of quality of each lead and means for generating a set of prime lead data from the leads that are evaluated as valid and have a predetermined measure of quality. The apparatus further includes means for providing the prime lead data to a recipient and means for determining compensation for the prime lead data based on a predetermined threshold conversion rate of leads included in the prime lead data into sales of a product.

(12) In another embodiment of the present invention, a method for commercializing prime lead data using a computer system includes receiving prime lead data and generating sales data associated with the prime data, wherein the sales data can be used to determine a conversion rate of leads included in the prime lead data to sales of a product. The method also includes providing compensation to a provider of the prime lead data if the conversion rate exceeds a predetermined threshold conversion rate.

(13) In a further embodiment of the present invention, a data processing system includes one or more processor. The method also includes a memory, coupled to the processor, having code stored therein and executable by the one or more processors for:
receiving prime lead data;
generating sales data associated with the prime data, wherein the sales data can be used to determine a conversion rate of leads included in the prime lead data to sales of a product; and
providing compensation to a provider of the prime lead data if the conversion rate exceeds a predetermined threshold conversion rate.

(14) In another embodiment of the present invention, an apparatus for commercializing prime lead data using a computer system includes means for receiving prime lead data. The apparatus also includes means for generating sales data associated with the prime data, wherein the sales data can be used to determine a conversion rate of leads included in the prime lead data to sales of a product and means for providing compensation to a provider of the prime lead data if the conversion rate exceeds a predetermined threshold conversion rate.

### BRIEF DESCRIPTION OF THE DRAWINGS

(15) The present invention may be better understood, and its numerous objects, features and advantages made apparent to those skilled in the art by referencing the accompanying drawings. The use of the same reference number throughout the several figures designates a like or similar element.

(16) FIG. 1 (labeled prior art) depicts a lead data purchase system.

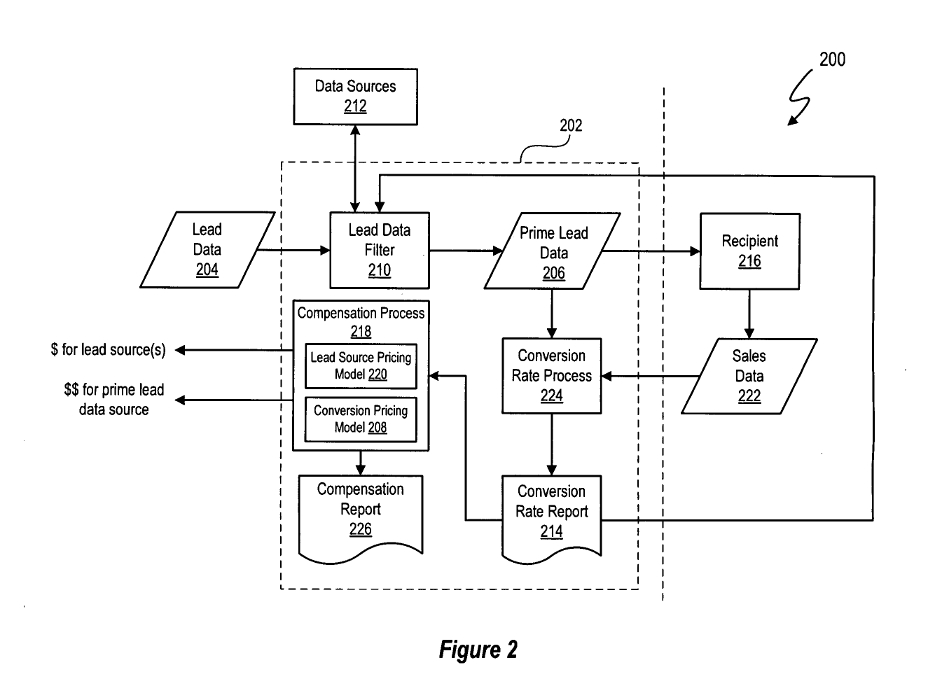

(17) FIG. 2 depicts an exemplary prime lead data commercialization system

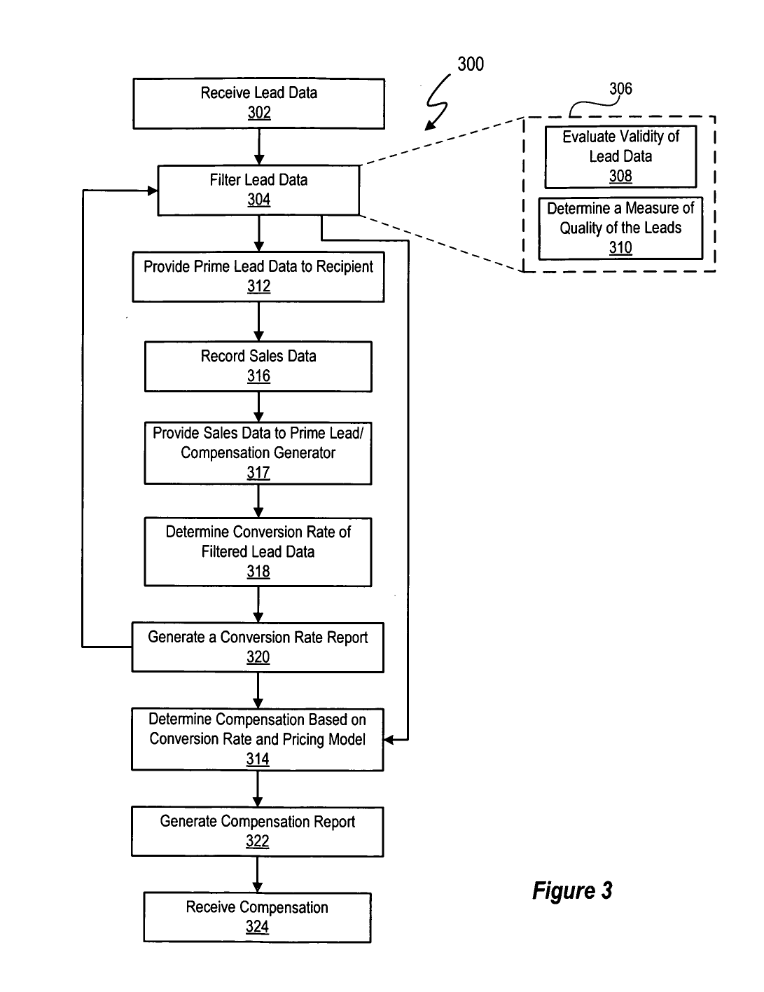

(18) FIG. 3 depicts an exemplary prime lead data commercialization method.

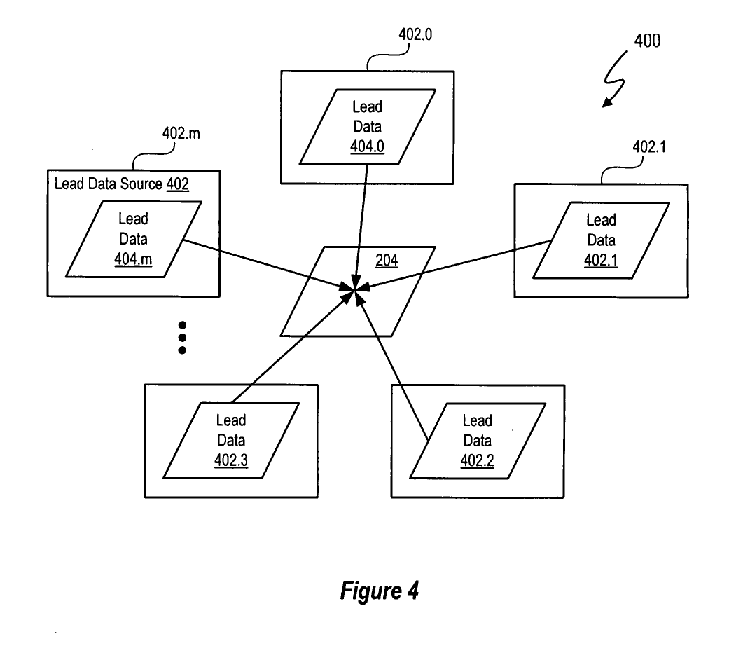

(19) FIG. 4 depicts a lead data collection system.

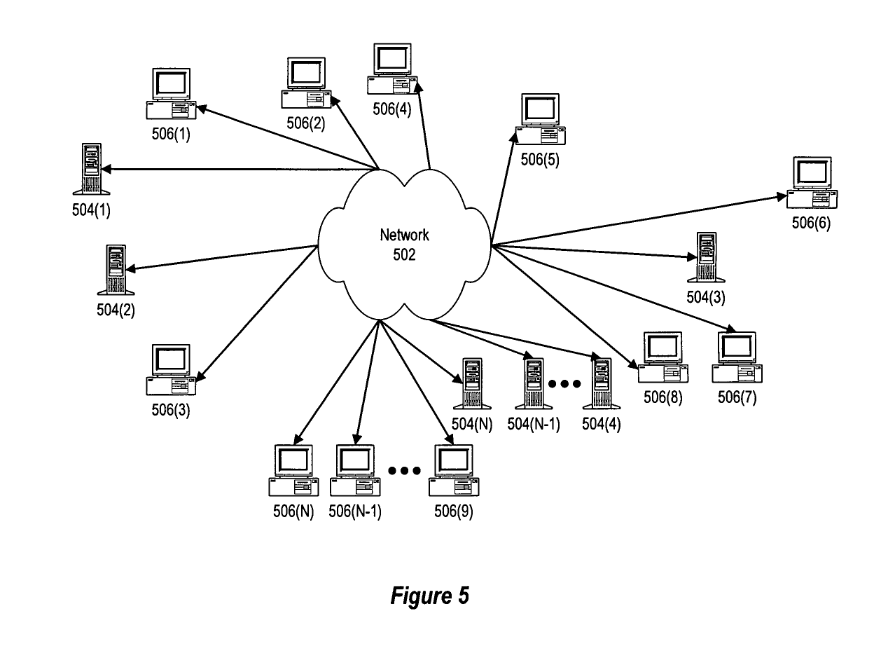

(20) FIG. 5 depicts a computer network system.

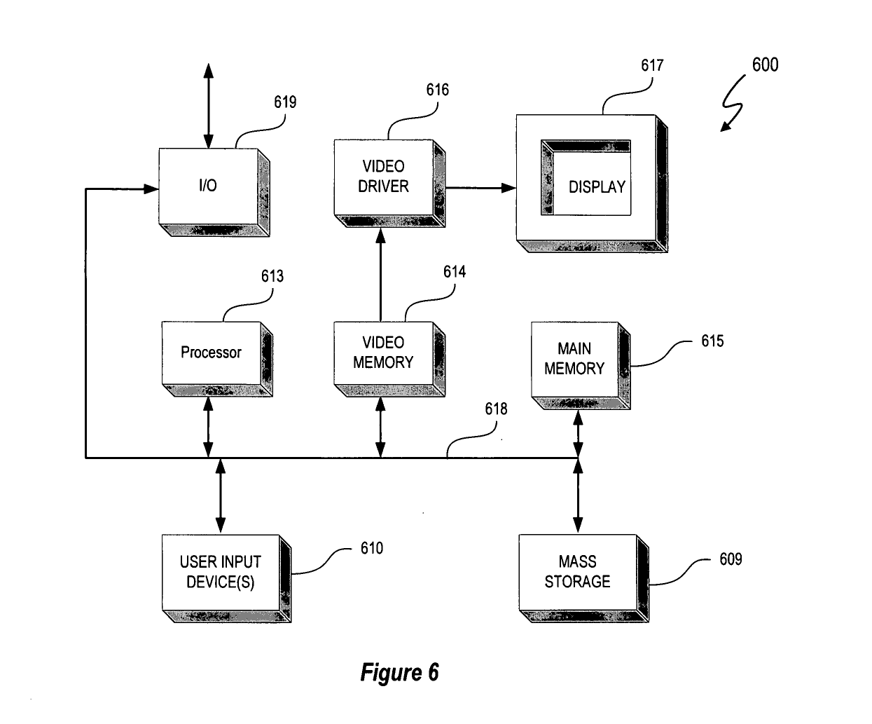

(21) FIG. 6 depicts a computer system.

### DETAILED DESCRIPTION

(22) A prime lead data commercialization system and method, in at least one embodiment, filters lead data to identify prime leads, provides the prime leads to a recipient, and determines compensation to the lead source based upon conversion rates. Because compensation is based upon conversion rates rather than simply providing the lead data, the risk of conversion shifts to the prime lead data source. In at least one embodiment, by shifting compensation risk to the lead source, the prime lead data source is able to obtain leads from any lead source without introducing arbitrary lead filtering criteria, such as filtering based on historically unacceptable conversion rates, that would have otherwise omitted quality leads. In at least one embodiment, the prime lead data source obtains lead data from other lead data sources. The prime lead data source can establish filter criteria that restricts the lead data that the prime lead data source purchases. Prime lead data has a non-linear value relationship with reference to conversion. For example, twice the probability of converting prime leads relative to the probability of converting non-prime leads, typically makes the prime lead data more than twice as valuable as non-prime lead data. Thus, the prime lead data commercialization system can determine compensation based upon a premium pricing model. Accordingly, the risks of compensation based on conversion rates can be offset by justified premium pricing models for prime leads.

(23) Additionally, in at least one embodiment, the prime lead data recipient can specify a conversion rate within a specified conversion rate range that must be achieved prior to compensating a prime lead data source. The prime lead data commercialization system and method can correlate lead data pricing with selected conversion rates so that, for example, a higher conversion rate selection correlates to higher lead data compensation if the conversion rate is achieved. Thus, the prime lead data commercialization system alters the conventional lead data business paradigm.

(24) In at least one embodiment, a lead recipient can utilizes a prime lead data commercialization system to immediately evaluate one or more received leads prior to purchasing the lead from a lead source. Based on the quality of the lead as determined by the prime lead data commercialization system, the lead recipient can decide whether to purchase the lead or decline the lead before any value of the lead diminishes via the passage of time. The term “immediate” includes latency times incurred via processing by the prime lead data commercialization system along with data transmission times.

(25) FIG. 2 depicts an exemplary prime lead data commercialization system 200 that, in at least one embodiment, operates in accordance with the exemplary prime lead data commercialization method 300 depicted in FIG. 3. In general, the exemplary prime lead data commercialization system 200 includes a prime lead/compensation generator 202 that processes lead data 204 to generate prime lead data 206. The exemplary prime lead data commercialization system 200 determines an amount of compensation for a prime lead data source based on conversion rates associated with the prime lead data 206 and a conversion pricing model 208. In at least one embodiment, the prime lead/compensation generator 202 operates in real-time to avoid, for example, data staleness.

(26) FIG. 4 depicts lead data collection system 400 which collects lead data from M+1 different lead data sources 402.0, 402.1, . . . , 402.M, where M is an integer greater than or equal to zero. The lead data 204 collected by lead data collection system 400 is input data to the prime lead/compensation generator 202. The lead data 204 can be stored in a memory and retrieved for processing by prime lead/compensation generator 202. Because the prime lead/compensation generator 202 determines compensation based upon conversion rate, in at least one embodiment, the prime lead/compensation generator 202 is able to expand the pool of lead data sources from which lead data is collected and, thus, omit arbitrary lead data filtering criteria. In other words, the lead data collection system 400 has the liberty to select any of lead data sources 402.0, 402.1, . . . , 402.M, without restriction, for processing by prime lead/compensation generator 202. The expansion of the pool of lead data sources allows prime lead/compensation generator 202 to identify leads that meet eligibility criteria that might otherwise be overlooked because of conventional arbitrary exclusion of some lead sources due to, for example, historically unacceptable conversion rates.

(27) The lead data 204 can be generated via any method, such as the methods described in conjunction with the generation of lead data in lead data purchase system 100. In at least one embodiment, the lead data 204 is organized into a common format for processing by lead data filter 210. For example, lead data 204 for each lead can be organized into a data structure having multiple fields. In at least one embodiment, the fields are: [First Name], [Last Name], [Telephone Number 1], [Telephone Number 2], [Zip Code], [Mailing Address], [E-Mail Address], [Product Configuration Data Fields], [Purchase Time Frame], [Acquisition Method], [Lead Source], [Origination Date], [Origination Time], [Comment Field(s)], [Other Product Specific Fields]. The “Product Configuration Data Fields” contain product configuration data such as a product model, make, and specific feature attributes. For example, in at least one embodiment, for an automobile product, the product configuration data fields include make, model, exterior color, interior color, trim, transmission, engine, wheels, and a variety of option and/or packages fields appropriate for the vehicle. The “Purchase Method” relates to the method of acquiring the product such as by leasing, financing, or cash purchase. The fields are flexible and can be adapted to reflect data field preferences used in filtering the lead data 204. The lead data 204 can be recorded and stored using a database, spread sheets, XML documents, or any other organizational system. Thus, the particular data fields, data structure, recording technology, and storing technology are a matter of design choice.

(28) Referring to FIGS. 2 and 3, in operation 302, the prime lead/compensation generator 202 receives lead data 204. In operation 304, lead data filter 210 filters the lead data 204 to identify the prime lead data 206. The prime lead data 206 has a predetermined minimum measure of quality. In at least one embodiment, lead data filter 210 identifies a set of leads with a probability of conversion that will achieve a conversion rate that results in compensation for the prime lead data 206 source. Thus, in at least one embodiment, the conversion rate probability of each lead in lead data 204 serves as a measure of quality threshold for determining whether or not to include a lead in prime lead data 206.

(29) In at least one embodiment, operation 304 includes two filtering operations 306. Validity evaluation operation 308 represents the first operation of filtering operation 306. In operation 308, the lead data filter 210 evaluates the validity of each lead in lead data 204 in accordance with a set of validation criteria. In at least one embodiment, the validity of each lead refers to determining whether at least a proper subset of the objectively verifiable fields for each lead meets the validation criteria. In at least one embodiment, the validation criteria represents which fields of each lead must have data and whether the data must be determined as a valid. For example, lead filter 210 can access a stored database and/or access remote data sources 212 to validate contact information. For example, operation 306 determines (i) if at least one of the submitted telephone numbers is a valid telephone number, (ii) if the telephone number is associated with the name of the lead, and (iii) if the ZIP code is valid and correlates with the submitted address. Lead data filter 210 can also check to see if the e-mail address is valid. If operation 306 determines that the lead data is invalid, in at least one embodiment, lead data filter 210 rejects the lead and, thus, does not identify the lead as a valid lead.

(30) Quality determination operation 310 represents the second operation of filtering operation 306. In operation 310, the lead data filter 210 determines a measure of quality for each valid lead in lead data 204 in accordance with quality criteria. In at least one embodiment, the quality criteria represents attributes of each lead and values for the attributes that can be objectively analyzed in determining the measure of quality. In at least one embodiment, the quality of a valid lead refers to a probability that the lead will convert to a sale. In at least one embodiment, lead data filter 210 can determine a measure of quality by weighting outcomes of various filtering operations and statistically determining a probability of the lead converting to a sale. In at least one embodiment, operation 310 contacts data sources 212 to obtain information that correlates to a measure of quality of each lead. For example, operation 310 can obtain from data sources 212 general demographic information for the lead in accordance with the lead address. The demographic information can be compared to the submitted product configuration and an evaluation can be made as to the likelihood that a purchaser associated with particular demographic information will purchase the submitted product. The data sources 212 can also include the product dealer, the original equipment manufacturer, and other third party data sources to determine whether the lead is a repeat customer. Repeat customers generally have a higher probability of converting to a sale.

(31) Operation 310 can also access product inventory of the recipient to determine whether the product identified by the lead is currently in the recipient's inventory or is readily available to a product dealer who will be using the prime lead data 206. Products not in inventory or readily available have reduced probability of conversion to a sale since the lead may attempt to locate the product elsewhere to obtain the product more quickly. Operation 310 can also determine a distance between the lead and the product dealer. In general, increasing distance between a lead and the product dealer lowers the probability of conversion to a sale, especially when sales are typically made at a physical location, such as a vehicle dealer. Operation 310 can also determine the age of the lead based on the lead origination time and date. Older leads are generally less likely to convert to a sale. Operation 310 can also determine whether various fields for a lead contain no data. Generally, having more data indicates the lead was a more serious prospective buyer and had a better idea of product interest, and, thus, is more likely to convert to a sale.

(32) The results of each determination by operation 310 can be weighted and processed in accordance with an optional statistical model of lead data filter 210 to determine a measure of quality of the valid leads of lead data 204. The particular statistical model is a matter of design choice and depends on, for example, the data collected for each lead and particular products offered.

(33) Additionally, characteristics of the statistical model of lead data filter 210 can be revised over time based on past performance to improve future performance of lead data filter 210. For example, previously generated conversion rate reports can be used as feedback to adjust the characteristics of lead data filter 210. Recursive analysis of the conversion rate reports and correlating prime leads of previous prime lead data 206 can be applied to revise lead data filter 210 and particularly the statistical model present in an embodiment of lead data filter 210. In at least one embodiment, the Microsoft SQL Server Analysis Services available from Microsoft Corp. of Redmond, Wash. can be used to process historical conversion rate report(s) 214, prime lead data 206, and the statistical model to improve the statistical model. In at least one embodiment, the recursive analysis can be used to better weight various attributes of the lead data 204 in order to improve future conversion rates.

(34) Compensation process 218 determines compensation based upon achieving a pre-defined conversion rate. Thus, in at least one embodiment, the conversion rate serves as a threshold for dividing leads in lead data 204 into prime lead data 206 and rejected leads.

(35) Although particular operations and embodiments of the lead data filter 210 have been described, the particular filter characteristics of lead data filter 210 and lead data filter operation 304 are a matter of design choice.

(36) Once operation 304 filters the lead data 204 to generate the prime lead data 206, operation 312 provides the prime lead data 206 to a recipient 216. The recipient 216 is, for example, an electronic data processing system of a product dealer. In at least one embodiment, the prime lead data 206 is provided electronically via a network, such as the internet.

(37) Prime lead data commercialization system 200 and method 300 can operate within any timeframe. For example, lead data can be received by operation 302, filtered by operation 304, and provided to a recipient 216 in operation 312 immediately, daily, weekly, or according to any other timeframe. For example, prime lead data commercialization system 200 and method 300 can provide a recipient 216 with an immediate indication of lead quality when the recipient 216 is presented with an opportunity to purchase one or more leads (lead(s)) provides the lead(s) to prime lead data commercialization system 200. The recipient 216 can review the results of operation 304 and purchase the lead(s), decline to purchase the lead(s), or purchase the lead(s) under modified payment terms. For example, the recipient 216 receives a lead via a lead source 404.0, such as an automated lead generation system. Recipient 216 provides the lead received from lead source 404.0 to prime lead data commercialization system 200 (via, for example, an electronic communication link) to determine the quality of the lead. If operation 304 determines that the lead has a higher likelihood of converting than an average conversion likelihood (for example, a 30% likelihood of converting versus an average conversion likelihood of 10%), the recipient 216 may decide to purchase the lead. A subsequent lead provided by the recipient 216 to prime lead data commercialization system 200 may be determined by operation 304 to have a lower than average likelihood of conversion (for example 3% versus an average conversion likelihood of 10%). The recipient 216 may immediately return the lead to the lead source 404.0 and decline to pay for the lead.

(38) Additionally, in at least one embodiment, operation 304 also provides information to compensation process 218 so that operation 314 can determine compensation for the lead sources that provided the prime lead data 206 to prime lead/compensation generator 202. In one embodiment, the prime lead data 206 is provided to compensation process 218, and operation 314 identifies the originator lead sources for each lead contained in the prime lead data 206. The compensation process 218 can include a pricing model that determines compensation for the lead sources. For example, if lead source 402.0 provided 100 leads in lead data 404.0 and 15 of the provided leads were selected for inclusion in prime lead data 206, compensation process 218 would compensate lead source 402.0 for the 15 leads. In another embodiment, compensation process compensation process 218 compensates a lead source for all the leads provided in lead data 204. The compensation scheme for each lead source or for one or more sets of lead sources 402.0, 402.1, . . . , 402.M is a matter of design, and each compensation scheme can be modeled by lead source pricing model 220.

(39) Once operation 312 provides the prime lead data 206 to recipient 216, the recipient 216 uses the prime lead data 206 to generate product sales. In operation 316, the recipient 216 records sales data 222. In at least one embodiment, the recorded sales data 222 includes data that can be used to provide feedback to lead data filter 210 in order to improve future conversion rates for future prime lead data 206. Thus, in at least one embodiment, the sales data 222 includes details about each sale such as buyer information (e.g. name, contact information, actual demographics, repeat customer information, etc.), product information (e.g. product make and model, product configuration details, etc.), sales information (e.g. date and time of sale, sales price, source of product (e.g. inventory or trade), method of purchase, product dealer comments, buyer comments, and any other information that could be useful for improving the lead data filter 210. In at least one embodiment, the sales data 222 also identifies prime lead data 206 as the source of the leads resulting in product sales. This identification can either be explicit by providing a lead source field in the sales data or implicit by only providing sales data about a lead to prime lead/compensation generator 202 if a lead in prime lead data 206 converted to a sale. The sales data 222 is preferably structured and formatted using an application that is prearranged for compatibility with prime lead/compensation generator 202.

(40) Operation 317 provides the sales data 222 to prime lead/compensation generator 202 using, for example, electronic transmission through a network such as the Internet.

(41) In operation 318, conversion data process 224 determines the conversion rate of the prime lead data 206. In at least one embodiment, the conversion rate is the percentage of leads in prime lead data 206 that converted into sales. The method of determining the conversion rate is a matter of design choice. In at least one embodiment, conversion rate process stores a conversion rate model that includes rules on how to determine a conversion rate. For example, the conversion rate model can include rules that specify which leads to use in determining a particular conversion rate. In at least one embodiment, operation 312 provides the prime lead data 206 to recipient 216 in batches, and operation 318 determines a conversion rate for each batch. In at least one embodiment, operation 318 determines a conversion rate for all prime lead data 206 submitted over a predetermined period of time. For example, in at least one embodiment, a single conversion rate is determined for all prime lead data 206 submitted during a single week, month, or any other predetermined period of time. In at least one embodiment, time restrictions are placed on operation 318 such that the leads in prime lead data 206 must be converted within a specified period of time in order to qualify as a conversion. In another embodiment, the time for conversion of a lead in prime lead data 206 is unrestricted, and conversion rate process 224 updates conversion rates as each lead is converted.

(42) Operation 320 generates conversion rate report 214 and provides the conversion rate report 214 to compensation process 218. The conversion rate report 214 specifies the conversion rate of the prime lead data 206 into sales as determined by conversion rate process 224. In at least one embodiment, the conversion rate report 214 also includes sales data 222. The conversion rate report 214, including sales data 222, are fed back to lead data filter 210 for use in improving future performance of lead data filter 210. In another embodiment, the sales data 222 is fed back directly to lead data filter 210 directly and is not included in the conversion rate report 214.

(43) In operation 314, compensation process 218 determines compensation for the prime lead data 206 using the conversion rate report 214 and conversion pricing model 208. The conversion pricing model 208 is a matter of design choice and, in at least one embodiment, represents a pricing agreement between a lead data source and a product dealer who will or is using the prime lead data 206. In at least one embodiment, the conversion pricing model 208 includes a set of rules that are used by compensation process 218 to determine compensation for conversion of leads included in the prime lead data 206. In at least one embodiment, compensation process 218 determines compensation based upon achieving a pre-defined conversion rate. The conversion rate can be fixed for at least a period of time and/or for a set of prime lead data 206. In at least one embodiment, the recipient of prime lead data 206 is allowed to select a conversion rate within a range of conversion rates. The conversion pricing model 208 includes rules for pricing the prime lead data 206 based upon a particular conversion rate. In at least one embodiment, the conversion pricing model 208 is a premium pricing model that reflects the risks incurred by the provider of the prime lead data 206. Thus, in at least one embodiment, higher selected conversion rates are associated with higher prices. Thus, if a conversion rate of 10% is chosen the price of the prime lead data 206 would be higher if the conversion rate is met than the price for the same prime lead data 206 for a lower conversion rate. In at least one embodiment, the conversion pricing model 208 can include rules to calculate bonuses as conversion rates increase.

(44) In operation 322, the compensation process 218 generates a compensation report 226. The compensation report 226 includes data specifying the amount of compensation, if any, owed by the recipient of the prime lead data 206 to the provider of the prime lead data 206. In at least one embodiment, the compensation report 226 includes details on how the amount of compensation was determined.

(45) In operation 324, the source of prime lead data 206 receives compensation in accordance with the compensation specified in the compensation report 226.

(46) Thus, the prime lead data commercialization system 200 and method 300 filters lead data to identify prime leads, provides the prime leads to a recipient, and determines compensation to the lead source based upon conversion rates.

(47) Many embodiments of the prime lead data commercialization system 200 have application to a wide range of industries and products including the following: computer hardware and software manufacturing and sales, professional services, financial services, automotive sales and manufacturing, telecommunications sales and manufacturing, medical and pharmaceutical sales and manufacturing, and construction industries.

(48) FIG. 5 is a block diagram illustrating a network system in which a prime lead data commercialization system 200 and method 300 may be practiced. Network 502 (e.g. a private wide area network (WAN) or the Internet) includes a number of networked server computer systems 504(1)-(N) that are accessible by client computer systems 506(1)-(N), where N is the number of server computer systems connected to the network. Communication between client computer systems 506(1)-(N) and server computer systems 504(1)-(N) typically occurs over a network, such as a public switched telephone network over asynchronous digital subscriber line (ADSL) telephone lines or high-bandwidth trunks, for example communications channels providing T1 or OC3 service. Client computer systems 506(1)-(N) typically access server computer systems 504(1)-(N) through a service provider, such as an internet service provider (“ISP”) by executing application specific software, commonly referred to as a browser, on one of client computer systems 506(1)-(N).

(49) Client computer systems 506(1)-(N) and/or server computer systems 504(1)-(N) may be, for example, computer systems of any appropriate design, including a mainframe, a mini-computer, a personal computer system including notebook computers, a wireless, mobile computing device (including personal digital assistants). These computer systems are typically information handling systems, which are designed to provide computing power to one or more users, either locally or remotely. Such a computer system may also include one or a plurality of input/output (“I/O”) devices coupled to the system processor (or processors) to perform specialized functions. Mass storage devices such as hard disks, compact disk (“CD”) drives, digital versatile disk (“DVD”) drives, and magneto-optical drives may also be provided, either as an integrated or peripheral device. One such example computer system is shown in detail in FIG. 6.

(50) Embodiments of the prime lead data commercialization system 200 and method 300 can be implemented on a computer system such as a general-purpose computer 600 illustrated in FIG. 6. Input user device(s) 610, such as a keyboard and/or mouse, are coupled to a bi-directional system bus 618. The input user device(s) 610 are for introducing user input to the computer system and communicating that user input to processor 613. The computer system of FIG. 6 generally also includes a video memory 614, main memory 615 and mass storage 609, all coupled to bi-directional system bus 618 along with input user device(s) 610 and processor 613. The mass storage 609 may include both fixed and removable media, such as other available mass storage technology. Bus 618 may contain, for example, 32 address lines for addressing video memory 614 or main memory 615. The system bus 618 also includes, for example, an n-bit data bus for transferring DATA between and among the components, such as CPU 609, main memory 615, video memory 614 and mass storage 609, where “n” is, for example, 32 or 64. Alternatively, multiplex data/address lines may be used instead of separate data and address lines.

(51) I/O device(s) 619 may provide connections to peripheral devices, such as a printer, and may also provide a direct connection to a remote server computer systems via a telephone link or to the Internet via an ISP. I/O device(s) 619 may also include a network interface device to provide a direct connection to a remote server computer system via a direct network link to the Internet via a POP (point of presence). Such connection may be made using, for example, wireless techniques, including digital cellular telephone connection, Cellular Digital Packet Data (CDPD) connection, digital satellite data connection or the like. Examples of I/O devices include modems, sound and video devices, and specialized communication devices such as the aforementioned network interface.

(52) Computer programs and data are generally stored as instructions and data in mass storage 609 until loaded into main memory 615 for execution. Computer programs may also be in the form of electronic signals modulated in accordance with the computer program and data communication technology when transferred via a network.

(53) The processor 613, in one embodiment, is a microprocessor manufactured by Motorola Inc. of Illinois, Intel Corporation of California, or Advanced Micro Devices of California. However, any other suitable single or multiple microprocessors or microcomputers may be utilized. Main memory 615 is comprised of dynamic random access memory (DRAM). Video memory 614 is a dual-ported video random access memory. One port of the video memory 614 is coupled to video amplifier 616. The video amplifier 616 is used to drive the display 617. Video amplifier 616 is well known in the art and may be implemented by any suitable means. This circuitry converts pixel DATA stored in video memory 614 to a raster signal suitable for use by display 617. Display 617 is a type of monitor suitable for displaying graphic images.

(54) The computer system described above is for purposes of example only. The prime lead data commercialization system 200 and method 300 may be implemented in any type of computer system or programming or processing environment. It is contemplated that the prime lead data commercialization method 300 can be executed as instructions stored in a memory and executed by a processor or processor of stand-alone computer system, such as the one described above. In at least one embodiment, the prime lead data commercialization method 300 can be executed as instructions stored in a memory and executed by one or more processors of one or more server computer systems system that can be accessed by a plurality of client computer systems interconnected over an intranet network. The prime lead data commercialization system 200 and method 300 may be run from a server computer system that is accessible to clients over the Internet.

(55) Although the present invention has been described in detail, it should be understood that various changes, substitutions and alterations can be made hereto without departing from the spirit and scope of the invention as defined by the appended claims.

What is claimed is:

1. A method for commercializing prime lead data using a computer system, the method comprising:
receiving lead data, wherein the lead data includes multiple leads and each lead includes information identifying a potential sales prospect;
determining a measure of quality of each lead;
generating a set of prime lead data from the leads that are evaluated as valid and have a predetermined measure of quality;
providing the prime lead data to a recipient; and
determining compensation for the prime lead data based on a predetermined threshold conversion rate of leads included in the prime lead data into sales of a product.

2. The method of claim 1 wherein the predetermined measure of quality measure comprises a probability of conversion that will allow the prime lead data to meet the predetermined threshold conversion rate.

3. The method of claim 1 wherein determining compensation for the prime lead data based on a predetermined threshold conversion rate of leads included in the prime lead data into sales of a product further comprises determining whether the leads included in the prime lead data converted to a sale within a predetermined period of time.

4. The method of claim 1 further comprising evaluating validity of the leads.

5. The method of claim 4 wherein evaluating validity of the leads comprises evaluating the validity of the leads in accordance with validation criteria, the method further comprising:
providing conversion data associated with the prime data leads as feedback to a lead data filter; and
revising the lead data filter using the feedback to modify the validation criteria.

6. The method of claim 4 wherein evaluating the validity of the leads comprises:
verifying accuracy of at least a subset of information included in each lead.

7. The method of claim 1 wherein determining a measure of quality of each lead comprises determining a measure of quality of each lead in accordance with quality criteria, the method further comprising:
providing conversion data associated with the prime data leads as feedback to a lead data filter; and
revising the lead data filter using the feedback to modify the quality criteria.

8. The method of claim 1 wherein the leads comprise information related to automotive products.

9. The method of claim 1 wherein the recipient comprises a data processing system of a product dealer.

10. A computer system comprising:
one or more processors, and
a memory, coupled to at least one of the one or more processors, having code stored therein and executable by at least one of the one or more processors for:
receiving lead data, wherein the lead data includes multiple leads and each lead includes information identifying a potential sales prospect;
determining a measure of quality of each lead;
generating a set of prime lead data from the leads that are evaluated as valid and have a predetermined measure of quality;
providing the prime lead data to a recipient; and
determining compensation for the prime lead data based on a predetermined threshold conversion rate of leads included in the prime lead data into sales of a product.

11. The computer system of claim 10 wherein the predetermined measure of quality measure comprises a probability of conversion that will allow the prime lead data to meet the predetermined threshold conversion rate.

12. The computer system of claim 10 wherein the code for determining compensation for the prime lead data based on a predetermined threshold conversion rate of leads included in the prime lead data into sales of a product is further configured for determining whether the leads included in the prime lead data converted to a sale within a predetermined period of time.

13. The computer system of claim 10 wherein the code is further configured for evaluating validity of the leads.

14. The computer system of claim 13 wherein the code for evaluating validity of the leads is further configured for evaluating the validity of the leads in accordance with validation criteria, and the code is further configured for:
providing conversion data associated with the prime data leads as feedback to a lead data filter; and
revising the lead data filter using the feedback to modify the validation criteria.

15. The computer system of claim 13 wherein the code for evaluating the validity of the leads is further configured for:
verifying accuracy of at least a subset of information included in each lead.

16. The computer system of claim 10 wherein the code for determining a measure of quality of each lead is further configured for determining a measure of quality of each lead in accordance with quality criteria, and the code is further configured for:
providing conversion data associated with the prime data leads as feedback to a lead data filter; and
revising the lead data filter using the feedback to modify the quality criteria.

17. The computer system of claim 10 wherein the leads comprise information related to automotive products.

18. The computer system of claim 10 wherein the recipient comprises a data processing system of a product dealer.

19. A computer readable medium comprising code stored therein and executable by one or more processors for:
receiving lead data, wherein the lead data includes multiple leads and each lead includes information identifying a potential sales prospect;
evaluating validity of the leads;
determining a measure of quality of each lead;
generating a set of prime lead data from the leads that are evaluated as valid and have a predetermined measure of quality;
providing the prime lead data to a recipient; and
determining compensation for the prime lead data based on a predetermined threshold conversion rate of leads included in the prime lead data into sales of a product.

20. The computer readable medium of claim 19 wherein the predetermined measure of quality measure comprises a probability of conversion that will allow the prime lead data to meet the predetermined threshold conversion rate.

21. The computer readable medium of claim 19 wherein the code for determining compensation for the prime lead data based on a predetermined threshold conversion rate of leads included in the prime lead data into sales of a product is further configured for determining whether the leads included in the prime lead data converted to a sale within a predetermined period of time.

22. The computer readable medium of claim 19 wherein the code is further configured for evaluating validity of the leads.

23. The computer readable medium of claim 22 wherein the code for evaluating validity of the leads is further configured for evaluating the validity of the leads in accordance with validation criteria, and the code is further configured for:
providing conversion data associated with the prime data leads as feedback to a lead data filter; and
revising the lead data filter using the feedback to modify the validation criteria.

24. The computer readable medium of claim 22 wherein the code for evaluating the validity of the leads is further configured for:
verifying accuracy of at least a subset of information included in each lead.

25. The computer readable medium of claim 19 wherein the code for determining a measure of quality of each lead is further configured for determining a measure of quality of each lead in accordance with quality criteria, and the code is further configured for:
providing conversion data associated with the prime data leads as feedback to a lead data filter; and
revising the lead data filter using the feedback to modify the quality criteria.

26. The computer readable medium of claim 19 wherein the leads comprise information related to automotive products.

27. The computer readable medium of claim 19 wherein the recipient comprises a data processing system of a product dealer.

28. An apparatus for commercializing prime lead data using a computer system, the apparatus comprising:
means for receiving lead data, wherein the lead data includes multiple leads and each lead includes information identifying a potential sales prospect;
means for determining a measure of quality of each lead;
means for generating a set of prime lead data from the leads that are evaluated as valid and have a predetermined measure of quality;
means for providing the prime lead data to a recipient; and
means for determining compensation for the prime lead data based on a predetermined threshold conversion rate of leads included in the prime lead data into sales of a product.

29. A method for commercializing prime lead data using a computer system, the method comprising:
receiving prime lead data;
generating sales data associated with the prime data;
using the sales data to determine a conversion rate of leads included in the prime lead data to sales of a product; and
providing compensation to a provider of the prime lead data if the conversion rate exceeds a predetermined threshold conversion rate.

30. The method of claim 29 wherein the received prime lead data comprises data that has been filtered and exceeds a measure of validity and a predetermined measure of quality.

31. The method of claim 30 wherein the predetermined measure of quality measure comprises a probability of conversion that will allow the prime lead data to meet the predetermined threshold conversion rate.

32. A data processing system comprising:
one or more processor; and
a memory, coupled to the processor, having code stored therein and executable by the one or more processors for:
receiving prime lead data;
generating sales data associated with the prime data;
using the sales data to determine a conversion rate of leads included in the prime lead data to sales of a product; and
providing compensation to a provider of the prime lead data if the conversion rate exceeds a predetermined threshold conversion rate.

33. The data processing system of claim 32 wherein the received prime lead data comprises data that has been filtered and exceeds a measure of validity and a predetermined measure of quality.

34. The data processing system of claim 32 wherein the predetermined measure of quality measure comprises a probability of conversion that will allow the prime lead data to meet the predetermined threshold conversion rate.

35. An apparatus for commercializing prime lead data using a computer system, the apparatus comprising:
means for receiving prime lead data;
means for generating sales data associated with the prime data;
means for using the sales data to determine a conversion rate of leads included in the prime lead data to sales of a product; and
means for providing compensation to a provider of the prime lead data if the conversion rate exceeds a predetermined threshold conversion rate.
